(19) United States
(12) Patent Application Publication
(10) Pub. No.: US 2014/0074625 A1
(43) Pub. Date: Mar. 13, 2014

(54) OPTIMIZING MULTI-LINE SYSTEMS WITH AUTO-BALANCING, RE-ORDERED DISTRIBUTION AND OPTIONAL RE-ENTRY

(71) Applicant: ARIIX, LLC, Bountiful, UT (US)

(72) Inventors: Fred William Cooper, Farmington, UT (US); Riley Paul Timmer, South Jordan, UT (US); Wenhan Zhang, Draper, UT (US)

(21) Appl. No.: 14/024,228

(22) Filed: Sep. 11, 2013

Related U.S. Application Data
(60) Provisional application No. 61/700,095, filed on Sep. 12, 2012.

(51) Int. Cl. G06Q 30/02

(52) U.S. Cl. CPC G06Q 30/0273
USPC 705/14.69

(57) ABSTRACT

Computers for enabling a distributor to build a distribution tree of essentially any width or depth and to receive commissions for the entire width and depth of the distribution tree. In some embodiments, building the multi-line compensation distribution plan includes transitioning a distributor's existing compensation plan that is limited in width, depth or width and depth to a new distribution plan that is unlimited in width and depth. In some embodiments, computers can cause a distributor to re-enter the distribution tree, within one or more downlines, thereby providing new income positions for the same distributor within a single distribution tree. Embodiments may include computer systems that auto-balance volume that is generated from the downlines, such that the volume is placed where it would generate the greatest amount of commissions or credits for a sponsoring distributorship.

### CROSS-REFERENCE TO RELATED APPLICATIONS

This application claims priority to U.S. Application No. 61/700,095 filed on Sep. 12, 2012, the disclosure of which is incorporated herein, in its entirety, by this reference.

### BACKGROUND OF THE INVENTION

1. The Field of the Invention

The present invention generally relates to computers configured to implement systems and compensation plans with multi-line structures and computers for optimizing commissions and for enabling substantially infinite variability in width and breadth of the genealogical structure of the compensation plans.

2. The Relevant Technology

Known compensation plans for multi-level marketing (MLM) companies include unilevel plans, matrix plans and binary plans.

In unilevel plans, a primary distributor has a single frontline of sponsored distributors that are directly beneath the primary distributor in their distribution tree. There can be an unlimited number of frontline distributors in this type of plan. The primary distributor will earn commissions off of each frontline distributor and that distributors' downline, i.e. distributors beneath a frontline distributor, but limited to a predetermined depth. Accordingly, unilevel plans are characterized as providing commissions for distribution trees of essentially infinite width, but only finite depth.

Binary plans are almost the exact opposite of unilevel plans. In binary plans, a primary distributor is only allowed a limited number of frontline distributors, but the primary distributor will receive commissions for the entire downline of each frontline distributor and the downline depth is not limited. Accordingly, binary plans are characterized as providing commissions for distribution trees of finite width, but essentially infinite depth.

Matrix plans include some aspects of unilevel plans and binary plans, namely a finite width and a finite depth. Matrix plans have a limited number of distributors who can be placed on each distributor's downline and there is a limited depth for each downline that the distributor will earn commissions off of.

There is currently a need for improved compensation plans, and automated systems to improve compensation plan structures, that are not limited by the width or the depth of the distribution tree for which a distributor is compensated.

### BRIEF SUMMARY

Embodiments may include computers for enabling a distributor to build a distribution tree of essentially any width or depth and to receive commissions for the entire width and depth of the distribution tree.

Embodiments may include computers with functionality for building and using a multi-line compensation distribution plan that is unlimited in width and unlimited in depth, as well as embodiments for compensating distributors of the compensation distribution plan. In some embodiments, building the multi-line compensation distribution plan includes transitioning a distributor's existing compensation plan that is limited in width, depth or width and depth to a new distribution plan that is unlimited in width and depth. For instance, in some embodiments, an existing binary plan, unilevel plan or matrix plan is mapped into or converted into a new distribution plan (unconstrained by width or depth) that enables the primary distributor to continue to develop the distribution tree in width and/or depth and to receive commissions for downlines that would not be available under the previous binary, unilevel or matrix plan from which the new compensation plan is developed. The new multi-line compensation/distribution plan provides for an unlimited potential number of pay lines (downlines) per income position.

In some embodiments, computers can cause a distributor to re-enter the distribution tree, within one or more downlines, thereby providing new income positions for the same distributor within a single distribution tree.

Embodiments of the invention may include computer systems that auto-balance volume that is generated from the downlines, such that the volume is placed where it would generate the greatest amount of commissions or credits for a sponsoring distributorship.

These and other features of various embodiments of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates a flow chart illustrating auto balancing for a single income position;

FIG. 2 illustrates a flow chart illustrating auto balancing for multiple income positions;

FIG. 3 illustrates one example of a result of an auto balance operation;

FIG. 4 illustrates another example of a result of an auto balance operation;

FIG. 5 illustrates another example of a result of an auto balance operation;

FIG. 6 illustrates a graphical representation of various multi-level marketing systems;

FIG. 7 illustrates various multi-level marketing systems overlaid on a multi-line system;

FIG. 8 illustrates re-entry of different income positions for an individual in a multi-level marketing system;

FIG. 9 illustrates re-entry of a different income position for an individual in a multi-level marketing system that does not follow a hierarchical line to the top level income position for the individual;

FIG. 10 illustrates a method of optimizing commissions in the multi-level marketing system;

FIG. 11 illustrates a method of optimizing commissions in the multi-level marketing system; and

FIG. 12 illustrates a method of optimizing commissions in the multi-level marketing system.

### DESCRIPTION OF THE EMBODIMENTS

Various embodiments of the invention will now be described. In describing these embodiments, various terms will be used. To assist in understanding the described embodiments, some of those terms will now be defined. The following terms are used with respect to a particular compensation scheme of one embodiment, but the terms may be applied differently in different compensation schemes.

The term “Auto-Balance” generally relates to the use of a unique algorithm and system for placing sales volume in a manner that will generate the most amount of commissions possible to an individual.

The term “Bonus” generally refers to additional commissions paid to individuals. This can be done for achieving higher levels of sales volumes on a line or by achieving higher numbers of lines, or for other appropriate reasons.

The term “Bucket” generally refers to points that are accumulated from the purchases of customers and additional orders of individuals that are available for auto-balancing.

The term “Cycle” generally refers to a given time period. For example, a cycle may be a period of 4 weeks (28 days). Although other cycles can also be used.

The term “Income Position” or “(IP)” generally refers to the location on a genealogical path in a distribution tree.

The term “Optimization” generally refers to earning the maximum amount of commissions on any single pay line.

The term “Payline” or “(PL)” generally refers to the second, third, or more lines in a downline that generate volume and subsequent commissions for individuals. As noted below, the first line is the powerline. The powerline, in the illustrated example, does not generate commissions for individuals.

The term “Point” generally refers to a credit value. Some embodiments equate a single point to $1 US and corresponding valuation for other currencies based on exchange rates against the US Dollar. However, other point valuations can also be used. Points can be achieved, for example, by an individual personally purchasing products or by certain customers purchasing products.

The acronym “POIP” refers to points that are auto-balanced to an Income Position to optimize a single payline per income position.

The acronym “POPL” refers to points that are auto-balanced to an Income Position to optimize more than one payline

The term “Powerline” generally refers to a line in a downline that that does not generate commissions for individuals. In the example illustrated below, the powerline is the line that accumulates the highest number of points.

The acronym “W1P” refers to “Where 1 point” and generally relates to the process in Auto-balancing where customer volume points are placed ($1=1 point) 1 point at a time in an individual's tree structure, such that commissions are maximized in regards to the rules of the compensation plan, assuring that volume is placed where commissions are maximized for a given pay period

As mentioned above, one embodiment of the invention includes auto-balancing.

### Auto Balancing

In the illustrated example, an individual needs a certain number of points in a given cycle to qualify for any commissions. A line generating the most points is the power line and does not pay any commission. Any other paylines, in the illustrated example, have a maximum $2,000 commission paid at 15% of generated points. Thus, 13,334 generated points will result in the maximum commission for a payline. All volume generated from either personal purchases or from volume for individuals below the given individual in excess of the qualification requirements for a cycle is “Auto-Balanced.” The algorithm of this process will guarantee the best placement of each individual point to generate the maximum commissions earned.

Single Income Position Auto Balance

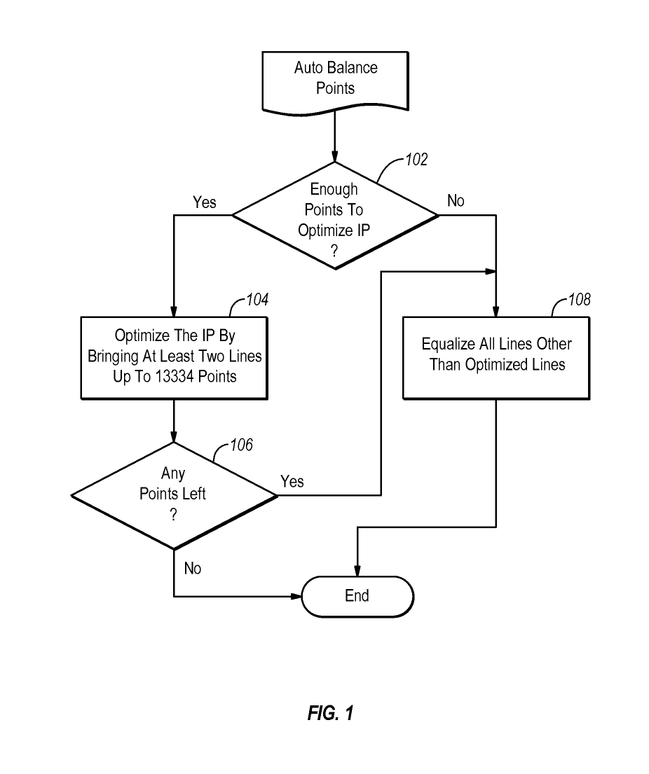

If an individual only has one income position, a computer system can implement the auto balance process to place the points in the following computer implemented steps (as illustrated in FIG. 1):
1) At act 102, a determination is made as to if there are enough points to optimize an income position. If there are enough points to optimize the income position, place all or part of the points in the line(s) to bring them to 13,334, or any other predefined number of points (act 104). In the illustrative example, this will earn a share in an income position bonus pool, and one or more shares in a pay line bonus pool, if more than three lines are optimized.
2) As illustrated at act 106, a determination is made to determine if any points are left after step 1. If any points are left after fulfilling step 1, as illustrated at act 108, these points will be placed in all available lines other than the optimized lines to best equalize the points across them. This will guarantee a maximum base commission.
3) If at act 102 it is determined by the system that the auto balance points are not enough to fulfill step 1, all points will be placed in all available lines to best equalize the points across all lines, as illustrated at act 108. This will guarantee a maximum base commission.

Multi-Income Position Auto Balance

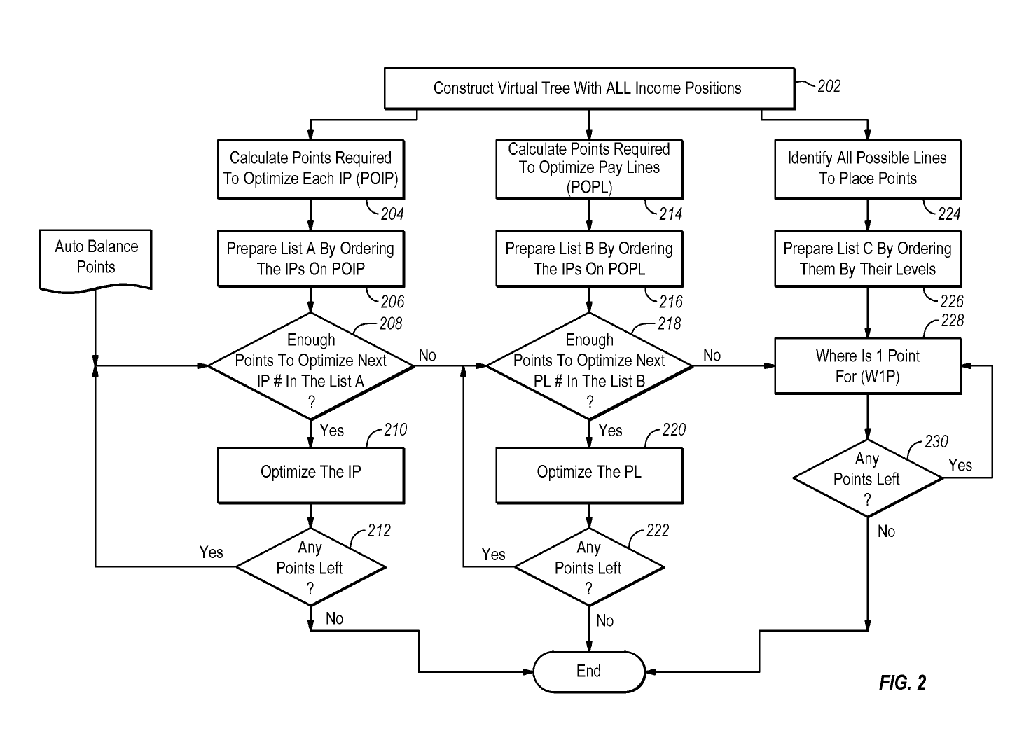

Referring now to FIG. 2, an embodiment is illustrated for optimizing income for an individual that has multiple income positions. If an individual has more than one income position, as illustrated at act 202, a virtual tree is constructed to only include all the individual's income positions connected by their genealogical relationship. The auto balance process will place the points in the following steps:
1) Optimize all income positions if possible to earn shares in an income position bonus pool:
   a. Calculate the points required to optimize each income position. (POIP) (act 204).
   b. Prepare a list by ordering all the income positions by POIP in ascending order, level of each income positions in the virtual tree in descending order. Thus, for example, when the system creates a list it will order the list first by the points required to optimize the income positions. This is done in ascending order so that the first income position on the list is the position that requires the smallest number of points to optimize, which leads to the most efficient use of the points available. If two different income positions need the same amount of points, then the positions are then ordered in descending order based on what level they are in the genealogical tree (level one being at the top of the tree). The reason for this is that the points roll up the tree, so if you plug in points at the bottom of the tree (e.g., level 5), it positively affects income positions higher up the tree (e.g., level 2).
   c. At act 208, it is determined that if there are enough points to optimize the first income position in the list prepared from step b, then, as illustrated at act 210, embodiments optimize the first income position by placing all or part of the points in the line(s) to bring them to 13,334 in the illustrated example, or any other predefined number of points. This will earn a share in the income position bonus pool.
   d. As illustrated at act 212, it is determined that if any points are left after fulfilling step c and enough to optimize the next income position in the list prepared in step b (as illustrated again by act 208), then embodiments optimize the next income position in the list (as illustrated again by act 210) by placing all or part of the points in the line(s) to bring them to 13,334, or any other predefined number of points. This will earn an additional share in the income position bonus pool
   e. Embodiments repeat step d until there are no points left or the points left are not enough to optimize the next income position in the list.
2) If any points left from fulfilling step 1, or the auto balance points are not enough to optimize any income positions, embodiments optimize pay lines in the income positions already optimized to earn shares in the pay line bonus pool:
   a. As illustrated at act 214, embodiments calculate the points required to optimize pay line(s) in the optimized income position. (POPL)
   b. As illustrated at act 216, embodiments prepare the list by ordering all the income positions by POPL in ascending order, level of each income positions in the virtual tree in descending order. See 1(b) above.
   c. As illustrated at act 218, if embodiments determine that there are enough points to optimize the pay line(s) in the first income position in the list prepared from step b, then, as illustrated at act 220, embodiments optimize the pay line(s) in the first income position by placing all or part of the points in the line(s) to bring them to 13,334, or any other predefined number of points. This will earn a share in the pay line bonus pool.
   d. As illustrated at act 222, if embodiments determine that any points are left after fulfilling step c and enough to optimize the pay line(s) in the next income position in the list prepared in step b, as illustrated again at act 218, then embodiments optimize the pay line(s) in the next income position, as illustrated again at act 220, by placing all or part of the points in the line(s) to bring them to 13334, or any other predefined number of points. This will earn additional shares in the pay line position bonus pool
   e. Embodiments repeat step d until there are no points left or the points left are not enough to optimize the next income position in the list.
3) A determination is made that if any points are left after step 1 and/or step 2, or the auto balance points are not enough to fulfill step 1 and/or 2, all points will be placed in the virtual tree by using the method of “where is 1 point good for?” (W1P).
   a. As illustrated at 224, embodiments identify all possible lines to place points in the virtual tree.
   b. As illustrated at 226, embodiments prepare a list by ordering them by their levels in the virtual tree in descending order.
Act 228 in FIG. 2 now represents steps c through g.
   c. Embodiments take 1 point from the bucket of auto balance points, and place it in the first line prepared in step b,
   d. The point is rolled up on the virtual tree and embodiments calculate the total base commission. (c$1)
   e. Embodiments change the point to the next line in the list, and repeat step d. (c$2)
   f. Embodiments compare the total commissions c$1 and c$2. If c$1>c$2, then embodiments keep the point in line position 1. If c$1<c$2, then embodiments keep the point in line position 2.
   g. Repeat the step e-f until a given point has been placed in all lines in the list and the best line is determined, which generates the highest commission.
   h. Repeat step c-g until all points in the bucket are placed in the virtual tree as determined at act 230.
      After all 3 steps, every point has been placed at the best place possible location where the maximum commission is guaranteed.

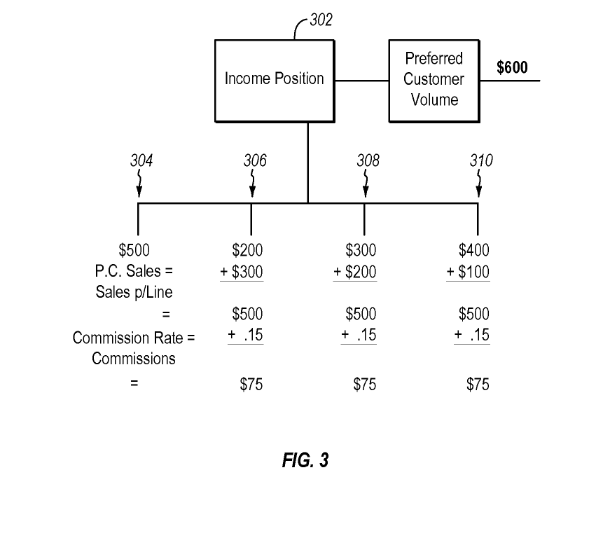

FIGS. 3-5 illustrate several examples of incomes increased based on point by point placement of sales generated by preferred customers. Based on the volume generated by Distributors, placement and amount of volume varies from week to week, or any other predefined period.

For example, FIG. 3 illustrates a case for an income position 302 which has a powerline 304 that generated $500 in sales, a first payline 306 that generated $200 in sales, a second payline 308 that generated $300 in sales and a third payline 310 that generated $400 in sales. For the income position 302, $600 or points were generated by sales to preferred customers, which points can be used to omptimize the income position 302. Because there are not sufficient points to bring both the power line 304 and the first payline 306 up to 13,334 points, the points are instead distributed across the paylines to maximize commissions. In this case, all paylines can be brought up to $500, exhausting the available points, to match the powerline 304, and thus commissions are maximized.

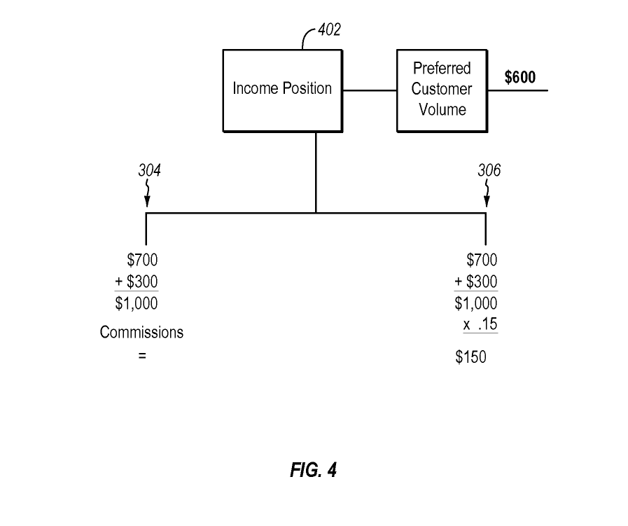

FIG. 4 illustrates an example where for an income position 402, there are enough points to increase the powerline 404, which also allows for an increase in the payline 406. By causing the powerline 404 and the payline 406 to have equal points, commissions are maximized.

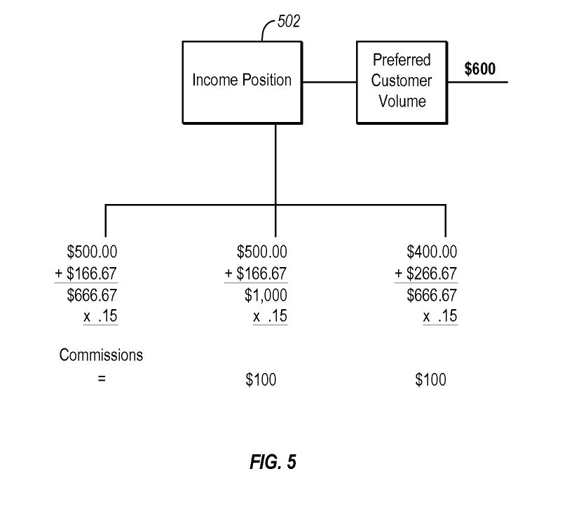

FIG. 5 illustrates an example of an income position 502, where by using available points, the powerline 504 can be increased by $166.67, which allows a first payline 506 to be increased by $166.67 and a second payline 508 to be increased by $266.67, to maximize commissions.

### Multi-Line Tree Structure

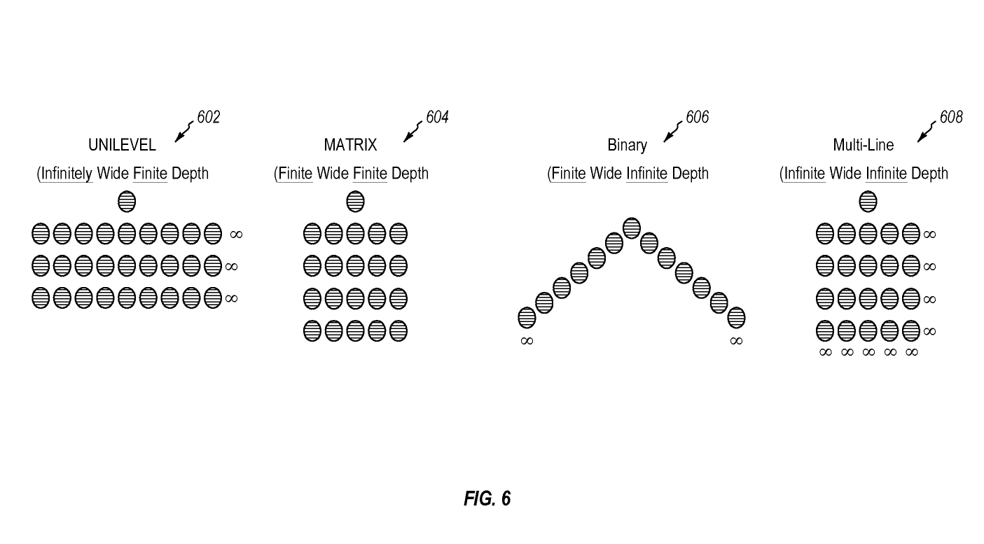

As described above, current MLM companies generally fall within three classifications of placement on individuals in a genealogical structure; namely, Unilevel, Matrix, and Binary. Each of these schemes is depicted in the Figures. For example, FIG. 6 illustrates a unilevel tree structure 602 with infinite width and finite depth. FIG. 6 also illustrates a matrix tree structure 604 with finite width and finite depth. FIG. 6 also illustrates a binary tree structure 606 having a finite width, but an infinite depth.

Some embodiments herein implement a “multi-line” trees structure 608. The multi-line tree structure 608 of some embodiments of the present invention allows for generations of commissions from individuals placed in a down-line regardless of the levels down (rows). Furthermore, the structure allows for commissions to be earned on an unlimited number of columns. Accordingly, the present invention provides for infinite depth and width, whereas all other types of current structures have a finite number of either rows (depth) or columns (width) allowed. Embodiments can be used to convert pre-existing structures to the infinite depth and width structure.

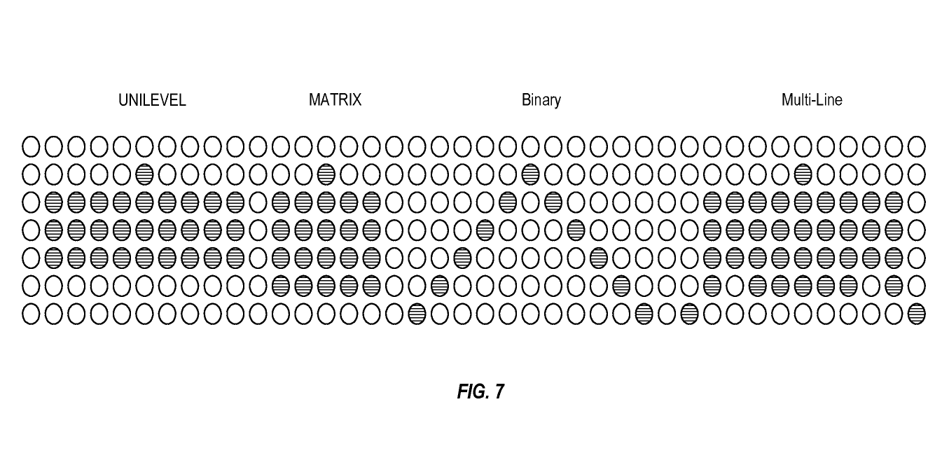

Currently, only the matrix tree structure 604 can be placed into the unilevel tree structure 602 without disrupting the parent/child relationship that exists between two organizations. Furthermore, the binary tree structure 606 cannot be merged into either the unilevel tree structure 602 or the matrix tree structure 604, or vice versa without changing the parent/child hierarchical structure. However, given that the multi-line accommodates both plans of infinite depth and width, companies can now merge compensation plans by adopting the multi-line structure as illustrated below. Alternatively, distributors can have their existing compensation plan mapped to the inventive multi-line distribution plan, such as is illustrated by FIG. 7, wherein the shaded patterns correspond to positions of existing plans or the new multi-line plan and wherein the new multi-line plan is shown that encompasses all of the other previous plans, which are mapped to the multi-line plan.

The shaded positions are actual positions and the un-shaded positions correspond to possible positions within the new multi-line plan(s). Actual positioning can be determined during mapping to ensure actual compensation within the new multi-line plan(s) will at least equal previous compensation from the another plan being mapped to the new multi-line plan.

### Crossline Re-Entry's

Some compensation plans, (almost exclusively found in the Binary) allow for Re-entry's. A Re-Entry is another position in the genealogical structure owned/occupied by the same individual or entity. Re-entry(s) enable individuals to reposition themselves under their current position somewhere in their down-line. The ability to pay commissions based on placement is fundamental to MLM structures.

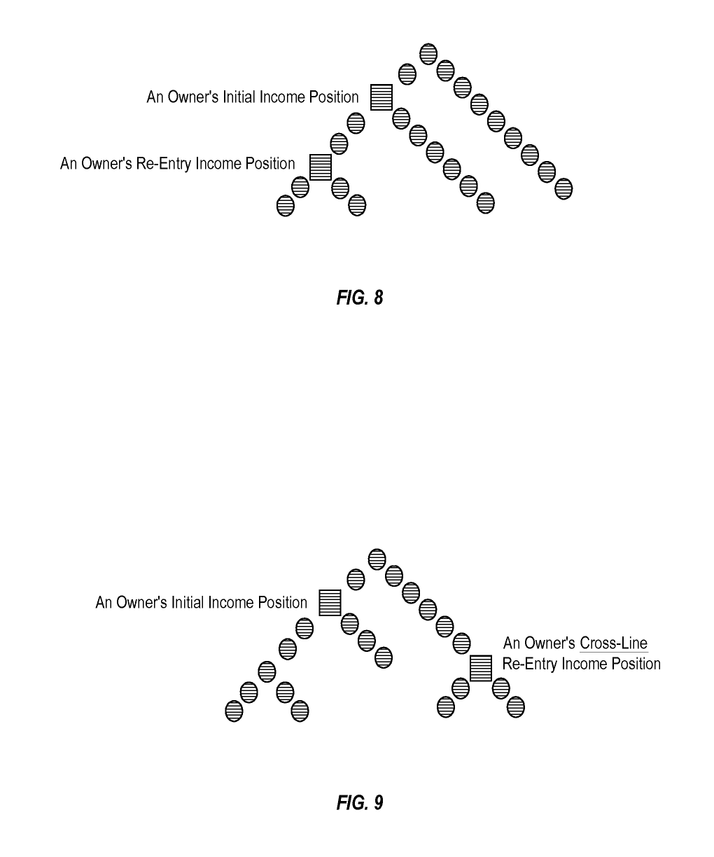

However, until now, a single business owner has not been able to build in two separate positions intentionally (some exceptions exist in the case of marriage, or inheritance but even under such circumstances the businesses are treated as two separate businesse' in terms of operation, point accumulation and recognition). FIG. 8 depicts how Re-entry's are typically placed in a Binary.

While flexibility is granted where Positions are allowed to be placed, all compensation plans generally require that a pathway exists from the bottom of the genealogical tree from one line ultimately up through the initial position. In the Multi-Line structure, Re-entry's are granted and placement is anywhere including cross-line to the initial income position, such as that illustrated in FIG. 9. Cross-line placement is the distinguishing characteristics since any volume which flows through a re-entry that is cross-line to the initial Income position would not have sales volume flow through both income positions.

By allowing infinite depth and width, re-entry's are allowed to be placed anywhere in an entire organization regardless of initial placement. The result is for individuals to work together in any team within an entire organizational structure worldwide, and still accumulate sales volume, group volume, achievements and recognition as a single entity rather than two distinct businesses. It also effectively allows individuals to build organizations away from the individual who initially sponsored them into the organization. Rules are put into place to assure that the sponsor of any individual is benefited continually regardless of the re-entry cross-line placed income position, while also generating commissions for those under whom the re-entry was placed. Placement therefore becomes fluid rather than ridged.

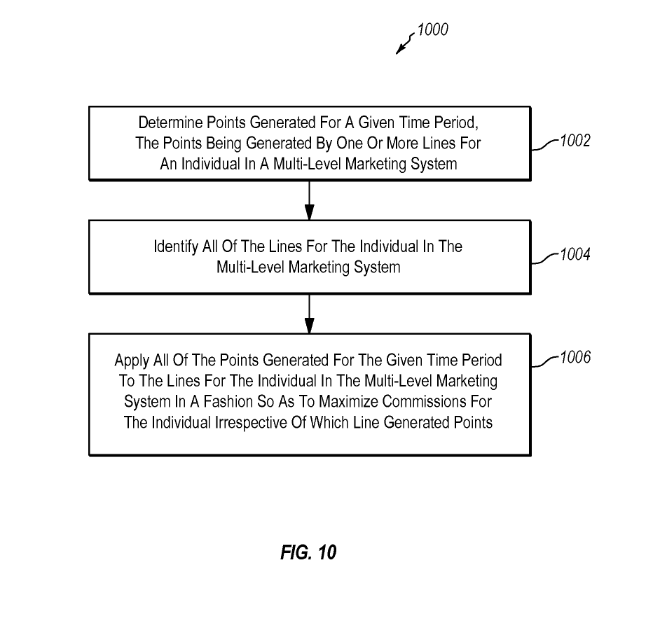

Referring now to FIG. 10, a method 1000 is illustrated. The method 1000 may be implemented using a computer system configured to optimize commissions in a multi-level marketing system. The method includes determining points generated for a given time period, the points being generated by one or more lines for an individual in a multi-level marketing system (act 1002). For example, FIGS. 3, 4, and 5 illustrate determining points generated by sales to preferred customers in a given period.

The method further includes identifying all of the lines for the individual in the multi-level marketing system (act 1004). Again, as illustrated in FIGS. 3, 4, and 5, different lines are identified. For example, in FIG. 3, power line 304 and payline 306 are identified.

The method further includes applying all of the points generated for the given time period to the lines for the individual in the multi-level marketing system in a fashion so as to maximize commissions for the individual irrespective of which line generated points (act 1006). Again, the examples illustrated in at least FIGS. 3-5 illustrate how this can be accomplished.

For example, the method 1000 may be implemented where applying all of the points generated for the given time period to the lines for the individual in the multi-level marketing system in a fashion so as to maximize commissions for the individual includes applying points to one or more of the lines to earn a maximum commission on the one or more of the lines and dividing any remaining points as equally as possible among remaining lines that do not have sufficient points applied to have a maximum commissions on those lines. Thus, for example, if the maximum commission is $2,000 per line, and commissions are 15% of points, then the maximum number of points that should be applied to a line is 13,334. This can be performed so long as there are sufficient points to bring lines up to the maximum commission for that line. This may qualify an individual for additional bonuses for meeting certain maximums. Once there are no longer sufficient points to bring a line up to the maximum commission for that line, the points can be divided as equally as possible over the other lines.

Alternatively, the method 1000 may be practiced where applying all of the points generated for the given time period to the lines for the individual in the multi-level marketing system in a fashion so as to maximize commissions for the individual includes applying points to one or more of the lines to earn a maximum commission on the one or more of the lines and applying one or more points to remaining lines that do not have sufficient points applied to have a maximum commission on those lines by, for each point applied to a remaining line, determining which line will generate the highest commission if the point is applied to that line. For example, this can be done by creating a hypothetical point distribution by distributing each given point on each line and determining the effect of the distribution on each line. Whichever distribution yields the highest commission will be made permanent and the point will be applied to that line.

The method 1000 may be practiced where the multi-level marketing system is a system that has a predetermined maximum width or depth. The method may further include converting the multi-level marketing system to a substantially unbounded system that does not have a predetermined limit of either width or depth by overlaying a representation of the multi-level marketing system on the substantially unbounded system. For example, FIG. 6 illustrates Unilevel, Matrix, and Binary bounded systems. As illustrated in FIG. 7, these systems can be converted to unbounded systems by overlaying them on an unbounded multi-line system.

The method 1000 may further include adding re-entry points for the individual into the multi-level marketing system allowing the individual to have different points in the multi-level marketing system for generating commissions. FIG. 8 illustrates an example where re-entry points have been added to a system. In some such embodiments, adding re-entry points for the individual into the multi-level marketing system includes adding one or more re-entry points for the individual that do not pass through a single top point for the individual in a hierarchy for the multi-level marketing system. An example of this is illustrated in FIG. 9.

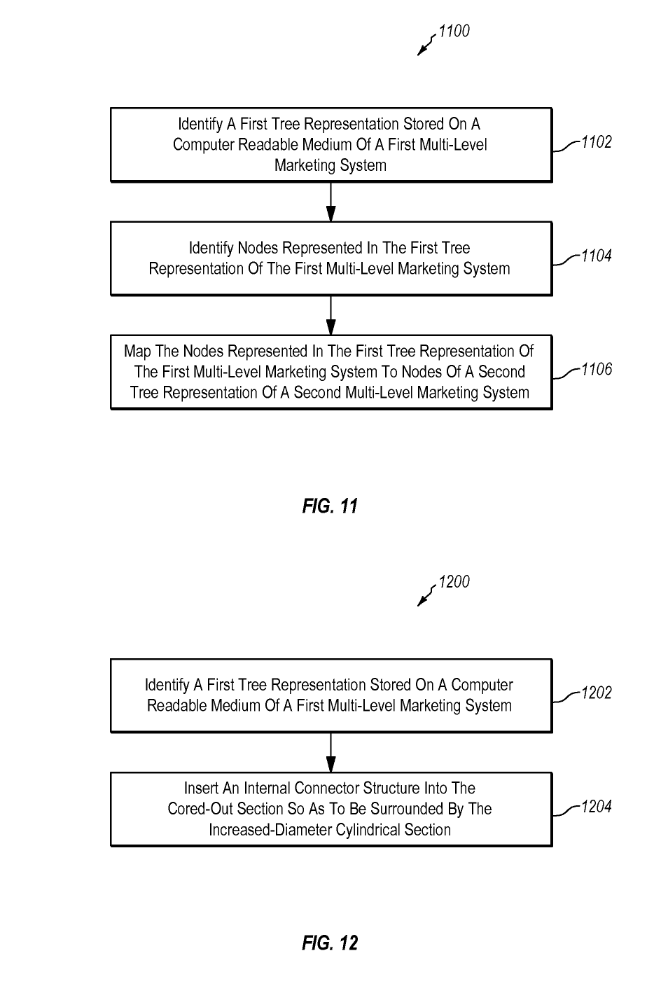

Referring now to FIG. 11, a method 1100 is illustrated. The method 1100 may be implemented by a computer system configured to optimize commissions in a multi-level marketing system. The method includes identifying a first tree representation stored on a computer readable medium of a first multi-level marketing system (act 1102).

The method further includes identifying nodes represented in the first tree representation of the first multi-level marketing system (act 1104).

The method further includes mapping the nodes represented in the first tree representation of the first multi-level marketing system to nodes of a second tree representation of a second multi-level marketing system (act 1106).

An example of the method 1100 is illustrated in the overlaying of multi-level marketing systems illustrated in FIGS. 6 and 7.

The method 1100 may be practiced where the first multi-level marketing system is a system that has a predetermined maximum width or depth and where the second multi-level marketing system is a substantially unbounded system that has essentially an unbounded limit of either width or depth.

The method 1100 may further include adding re-entry points for an individual into the second multi-level marketing system allowing the individual to have different points in the second multi-level marketing system for generating commissions. As noted, examples of this are illustrated by FIG. 8. In some such embodiments, as illustrated by FIG. 9, adding re-entry points for the individual into the second multi-level marketing system includes adding one or more re-entry points for the individual that do not pass through a single top point for the individual in a hierarchy for the second multi-level marketing system.

The method 1100 may further include the following acts:

Determining points generated for a given time period, the points being generated by one or more lines for an individual in the second multi-level marketing system; identifying all of the lines for the individual in the second multi-level marketing system; and applying all of the points generated for the given time period to the lines for the individual in the second multi-level marketing system in a fashion so as to maximize commissions for the individual irrespective of which line generated points.

In some such embodiments, applying all of the points generated for the given time period to the lines for the individual in the second multi-level marketing system in a fashion so as to maximize commissions for the individual includes applying points to one or more of the lines to earn a maximum commission on the one or more of the lines and dividing any remaining points as equally as possible among remaining lines that do not have sufficient points applied to have a maximum commissions on those lines. Alternatively or additionally, applying all of the points generated for the given time period to the lines for the individual in the second multi-level marketing system in a fashion so as to maximize commissions for the individual may include applying points to one or more of the lines to earn a maximum commission on the one or more of the lines and applying one or more points to remaining lines that do not have sufficient points applied to have a maximum commission on those lines by, for each point applied to a remaining line, determining which line will generate the highest commission if the point is applied to that line.

Referring now to FIG. 12, a method 1200 is illustrated. The method 1200 may be practiced by a computer system configured to optimize commissions in a multi-level marketing system. The method 1200 includes identifying a first tree representation stored on a computer readable medium of a first multi-level marketing system (act 1202). The method 1200 further includes adding re-entry points for an individual into the first multi-level marketing system allowing the individual to have different points in the first multi-level marketing system for generating commissions (act 1204).

The method 1200 may be practiced where adding re-entry points for the individual into the multi-level marketing system includes adding one or more re-entry points for the individual that do not pass through a single top point for the individual in a hierarchy for the multi-level marketing system.

Various embodiments and features associated with the creation and use of the multi-line compensation plans have been described above. It will be appreciated that these embodiments include the use of specialized computing systems having hardware (e.g., processors, memory, input and output devices) that are configured to process executable instructions that are accessed by or stored by the computing systems and that, when executed, implement the functionality described herein and which also extends to automatic identification, tracking and payment of commissions for the distribution lines, as well as auto-mapping and generation of new multi-line distribution trees that correspond to existing compensation plans, and for performing the auto-balancing or any other functionality described herein.

To further emphasize the use of specialized computer systems, it will be appreciated that the present invention also extends to embodiments that include or utilize a special purpose or general-purpose computer including computer hardware, and physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes hardware storage devices such as RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other hardware medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, such as a physical hardware processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts (which are implemented by a specialized computing system or network of computing systems), it is to be understood that the subject matter defined in the appended claims is not necessarily limited to the described features or acts described above. Rather, the described features and acts are disclosed as non-limiting examples of implementing the invention.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency are to be embraced within their scope.

What is claimed is:

1. A computer system configured to optimize commissions in a multi-level marketing system, the computer system comprising:
one or more physical processors;
one or more physical computer readable media coupled to the one or more memory, the one or more physical computer readable media comprising computer executable instructions that when executed by the one or more processors causes the following to be performed:
determining points generated for a given time period, the points being generated by one or more lines for an individual in a multi-level marketing system;
identifying all of the lines for the individual in the multi-level marketing system;
applying all of the points generated for the given time period to the lines for the individual in the multi-level marketing system in a fashion so as to maximize commissions for the individual irrespective of which line generated points.

2. The computer system of claim 1, wherein applying all of the points generated for the given time period to the lines for the individual in the multi-level marketing system in a fashion so as to maximize commissions for the individual irrespective of which line generated points comprises applying points to one or more of the lines to earn a maximum commission on the one or more of the lines and dividing any remaining points as equally as possible among remaining lines that do not have sufficient points applied to have a maximum commissions on those lines.

3. The computer system of claim 1, wherein applying all of the points generated for the given time period to the lines for the individual in the multi-level marketing system in a fashion so as to maximize commissions for the individual irrespective of which line generated points comprises applying points to one or more of the lines to earn a maximum commission on the one or more of the lines and applying one or more points to remaining lines that do not have sufficient points applied to have a maximum commission on those lines by, for each point applied to a remaining line, determining which line will generate the highest commission if the point is applied to that line.

4. The computer system of claim 1, wherein the multi-level marketing system is a system that has a predetermined maximum width or depth, and wherein the computer system further comprises computer executable instructions that when executed by the one or more processors causes the multi-level marketing system to be converted to an substantially unbounded system that does not have a predetermined limit of either width or depth by overlaying a representation of the multi-level marketing system on the substantially unbounded system.

5. The computer system of claim 1, wherein the computer system further comprises computer executable instructions that when executed by the one or more processors causes the multi-level marketing system to add re-entry points for the individual into the multi-level marketing system allowing the individual to have different points in the multi-level marketing system for generating commissions.

6. The computer system of claim 5, wherein causing the multi-level marketing system to add re-entry points for the individual into the multi-level marketing system comprises adding one or more re-entry points for the individual that do not pass through a single top point for the individual in a hierarchy for the multi-level marketing system.

7. A computer system configured to optimize commissions in a multi-level marketing system, the system comprising:
one or more physical processors;
one or more physical computer readable media coupled to the one or more memory, the one or more physical computer readable media comprising computer executable instructions that when executed by the one or more processors causes the following to be performed:
identifying a first tree representation stored on a computer readable medium of a first multi-level marketing system;
identifying nodes represented in the first tree representation of the first multi-level marketing system; and
mapping the nodes represented in the first tree representation of the first multi-level marketing system to nodes of a second tree representation of a second multi-level marketing system.

8. The computer of claim 7, wherein the first multi-level marketing system is a system that has a predetermined maximum width or depth and wherein the second multi-level marketing system is a substantially unbounded system that has essentially an unbounded limit of either width or depth.

9. The computer system of claim 7, wherein the computer system further comprises computer executable instructions that when executed by the one or more processors causes the computer system to add re-entry points for an individual into the second multi-level marketing system allowing the individual to have different points in the second multi-level marketing system for generating commissions.

10. The computer system of claim 9, wherein causing the second multi-level marketing system to add re-entry points for the individual into the second multi-level marketing system comprises adding one or more re-entry points for the individual that do not pass through a single top point for the individual in a hierarchy for the second multi-level marketing system.

11. The computer system of claim 7, wherein the computer system further comprises computer executable instructions that when executed by the one or more processors causes the following to be performed:
determining points generated for a given time period, the points being generated by one or more lines for an individual in the second multi-level marketing system;
identifying all of the lines for the individual in the second multi-level marketing system;
applying all of the points generated for the given time period to the lines for the individual in the second multi-level marketing system in a fashion so as to maximize commissions for the individual irrespective of which line generated points.

12. The computer system of claim 11, wherein applying all of the points generated for the given time period to the lines for the individual in the second multi-level marketing system in a fashion so as to maximize commissions for the individual irrespective of which line generated points comprises applying points to one or more of the lines to earn a maximum commission on the one or more of the lines and dividing any remaining points as equally as possible among remaining lines that do not have sufficient points applied to have a maximum commissions on those lines.

13. The computer system of claim 11, wherein applying all of the points generated for the given time period to the lines for the individual in the second multi-level marketing system in a fashion so as to maximize commissions for the individual irrespective of which line generated points comprises applying points to one or more of the lines to earn a maximum commission on the one or more of the lines and applying one or more points to remaining lines that do not have sufficient points applied to have a maximum commission on those lines by, for each point applied to a remaining line, determining which line will generate the highest commission if the point is applied to that line.

14. A computer system configured to optimize commissions in a multi-level marketing system, the system comprising:
one or more physical processors;
one or more physical computer readable media coupled to the one or more memory, the one or more physical computer readable media comprising computer executable instructions that when executed by the one or more processors causes the following to be performed:
identifying a first tree representation stored on a computer readable medium of a first multi-level marketing system; and
adding re-entry points for an individual into the first multi-level marketing system allowing the individual to have different points in the first multi-level marketing system for generating commissions.

15. The computer system of claim 14, wherein causing the multi-level marketing system to add re-entry points for the individual into the multi-level marketing system comprises adding one or more re-entry points for the individual that do not pass through a single top point for the individual in a hierarchy for the multi-level marketing system.

16. The computer system of claim 14, wherein the computer system further comprises computer executable instructions that when executed by the one or more processors causes the following to be performed:
determining points generated for a given time period, the points being generated by one or more lines for an individual in the first multi-level marketing system;
identifying all of the lines for the individual in the first multi-level marketing system;
applying all of the points generated for the given time period to the lines for the individual in the first multi-level marketing system in a fashion so as to maximize commissions for the individual irrespective of which line generated points.

17. The computer system of claim 16, wherein applying all of the points generated for the given time period to the lines for the individual in the second multi-level marketing system in a fashion so as to maximize commissions for the individual irrespective of which line generated points comprises applying points to one or more of the lines to earn a maximum commission on the one or more of the lines and dividing any remaining points as equally as possible among remaining lines that do not have sufficient points applied to have a maximum commissions on those lines.

18. The computer system of claim 16, wherein applying all of the points generated for the given time period to the lines for the individual in the first multi-level marketing system in a fashion so as to maximize commissions for the individual irrespective of which line generated points comprises applying points to one or more of the lines to earn a maximum commission on the one or more of the lines and applying one or more points to remaining lines that do not have sufficient points applied to have a maximum commission on those lines by, for each point applied to a remaining line, determining which line will generate the highest commission if the point is applied to that line.

19. The computer system of claim 14, wherein the computer system further comprises computer executable instructions that when executed by the one or more processors causes the following to be performed:
identifying a first tree representation stored on a computer readable medium of the first multi-level marketing system;
identifying nodes represented in the first tree representation of the first multi-level marketing system; and
mapping the nodes represented in the first tree representation of the first multi-level marketing system to nodes of a second tree representation of a second multi-level marketing system.

20. The computer system of claim 19, wherein the first multi-level marketing system is a system that has a predetermined maximum width or depth and wherein the second multi-level marketing system is a substantially unbounded system that has essentially an unbounded limit of either width or depth
